(19) United States
(12) Patent Application Publication
(10) Pub. No.: US 2012/0265561 A1
(43) Pub. Date: Oct. 18, 2012

(54) ONLINE MARKETPLACE METHODS FACILITATING LOCAL COMMERCE

(76) Inventor: Jatin Patro, Beaverton, OR (US)

(21) Appl. No.: 13/086,112

(22) Filed: Apr. 13, 2011

(51) Int. Cl. G06Q 30/00; G06Q 50/00; G06Q 10/00

(52) U.S. Cl. 705/5; 705/26.61; 705/15

(57) ABSTRACT

A method for online electronic commerce including defining, by a processing unit executing logic, vendor parameters for each at least one of goods and services offered by each vendor, receiving consumer search queries, comparing, with the processing unit executing logic, the vendor parameters with the consumer search queries, and displaying to the consumers for purchase consideration the vendor parameters compatible with the consumer search queries. In some examples, the vendor parameters include a vendor defined product category, a product description, and one or more of local pickup parameters and local delivery parameters. In some examples, the consumer search queries include a consumer desired product category and one or more of local pickup preferences and local delivery preferences.

### BACKGROUND

The present invention generally relates to the field of ecommerce. More particularly, the present invention relates to an online, automated marketplace for buying and selling goods and services.

Most business-to-consumer retailers today, maintain an online presence for selling goods and services to consumers. From ordering a pizza online and having it delivered to your front door on the day ordered or even weeks later, to purchasing practically any given product or good online and having it shipped to your door step, electronic retail or e-tail is ubiquitous. Consumer-to-consumer sales are typically conducted online in a virtual garage sale environment for buying and selling second hand or used items. Additionally, online marketplace transactions can be conducted in an auction environment where the buyer uses a price-bidding scheme. As consumers, vendors, and suppliers become increasingly dependent on ecommerce, brick-and-mortar businesses continually develop a more robust online presence in a virtual environment to mimic their sales, supplier purchases, and logistics.

While the types of ecommerce described above have various advantages and disadvantages in different situations, a commonality among typical ecommerce transactions is the buyer and the seller are not afforded the opportunity to mutually schedule product availability with product delivery or pickup.

Accordingly, there is a need in the art for establishing a virtual online marketplace environment that provides fully automated local sales and scheduling solutions for all types of businesses and individual buyers and sellers.

### BRIEF DESCRIPTION OF THE DRAWINGS

Many aspects of the present invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view or a programmable computing device for carrying out the online marketplace methods described herein.

FIG. 2 is a flow diagram of a first online marketplace method.

FIG. 2A is an example of a screen display illustrating the vendor calendar of a first online marketplace.

FIG. 3 is a flow diagram of a second online marketplace method.

FIG. 4 is a flow diagram of a third online marketplace method, which accommodates ordering and paying for meals at a restaurant in advance.

FIG. 5 is an example of a screen display illustrating the date and time sensitivity of the disclosed online marketplace methods.

FIG. 6 is an example of a screen display illustrating a meal-ordering transaction accordance with method shown in FIG. 4.

### DETAILED DESCRIPTION

Non-limiting embodiments of the present invention utilize an automated, schedule-sensitive shopping cart system, where goods and services are made available by schedule and ordered for a specific date and time.

The following includes definitions of selected terms employed herein. The definitions include various examples and/or forms of components that fall within the scope of a term and that may be used to implement the disclosed methods. The examples are not intended to be limiting. Both singular and plural forms of terms may be within the definitions.

As used in this application, the term “computing unit” refers to a computer-related entity, hardware, firmware, software, a combination thereof, or software in execution. For example, a computing unit can be, but is not limited to being, a process running on a processor unit, a processor, an object, an executable, a thread of execution, a program, and a computer. By way of illustration, both an application running on a server and the server can be computing units. One or more computing units can reside within a process and/or thread of execution and a computing unit can be localized on one computer and/or distributed between two or more computers.

“System memory,” as used herein, refers to a medium that participates directly or indirectly to provide signals, instructions and/or data. A system memory may take forms, including, but not limited to, non-volatile media, and volatile media. Non-volatile media may include, for example, optical or magnetic disks and so on. Volatile media may include, for example, optical or magnetic disks, dynamic memory and the like. Common forms of a system memory include computer-readable medium such as, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM or other memory chip or card, a memory stick, and other media from which a computer, a processor or other electronic device can read.

“Shared data storage,” as used herein, refers to a physical and/or logical entity that can store data. Data storage may be, for example, a database, a table, a file, a list, a queue, a heap, a memory, a register, a file directory, a storage location, and so on. Data storage may reside in one logical and/or physical entity and/or may be distributed between two or more logical and physical entities.

“Logic,” as used herein, includes but is not limited to hardware, firmware, software and/or combinations of each to perform a function(s) or an action(s), and/or to cause and execute a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software, or may be a computing unit as defined herein. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, PHP, SQL, APIs, SDKs, assembly, firmware, microcode, and/or other languages and tools. Software, whether an entire system or a component of a system, may be embodied as an article of manufacture and maintained or provided as part of a computer-readable memory as indicated previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also he used.

“User,” as used herein, includes but is not limited to one or more persons, software, computers or other devices, or combinations of these.

The term “goods and services” as used herein, is defined as a continuum with physical goods on one end and intangible services on the other. The term “product” falls between these two ends and may be used to represent a “good” or “goods.” The term “goods” and the term “services” may be used independently of the term “goods and services.” Goods may be further categorized, for example, as artisan goods, farm products, food products, store goods, used goods, and so on. Services may be, for example, educational, household, personal care, professional (income tax, accounting, legal etc . . . ), catering, child care, entertainment, memberships, recreational, table reservations and meal-ordering.

“Seller,” as used herein, includes but is not limited to the provider of the goods or services. The seller completes a sale in response to an acquisition or to a request. It will be appreciated by one of ordinary skill in the art that a seller may take the form of a vendor, for example, in a supply chain, but a seller is not limited to being a supplier. For all intents and purposes, a “vendor,” as used herein, is a seller.

“Buyer,” as used herein, includes any person who contracts to acquire goods and services in return for some form of consideration. The buyer may initiate a sale through a request for particular goods and services. It be appreciated by one of ordinary skill in the art that a buyer may take the form of a customer, for example, in a supply chain, but a buyer is not limited to being a customer. It will also be appreciated that a buyer can be a seller in another transaction for the same good and/or service.

“Consumer,” as used herein, includes any person or entity who is capable of consuming the goods and services produced. It will be appreciated by one of ordinary skill in the art that a consumer can be both a seller and a buyer depending on the type of sale.

“Cash on Delivery”, also commonly referred to as “Collect on Delivery” or “Offline Payment”, as used herein, includes any method or form of payment made in person, by an individual or entity representing the buyer to an individual or entity representing the seller in exchange for one or more products purchased. The form of payment includes, but is not limited to cash, check, voucher, debit card, and credit card payment.

Some portions of the detailed descriptions that follow are presented in terns of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like defining, receiving, comparing, displaying, or the like, refer to actions and processes of a computer system, logic, processor, or similar electronic device that manipulates and transforms data represented as physical (electronic) quantities.

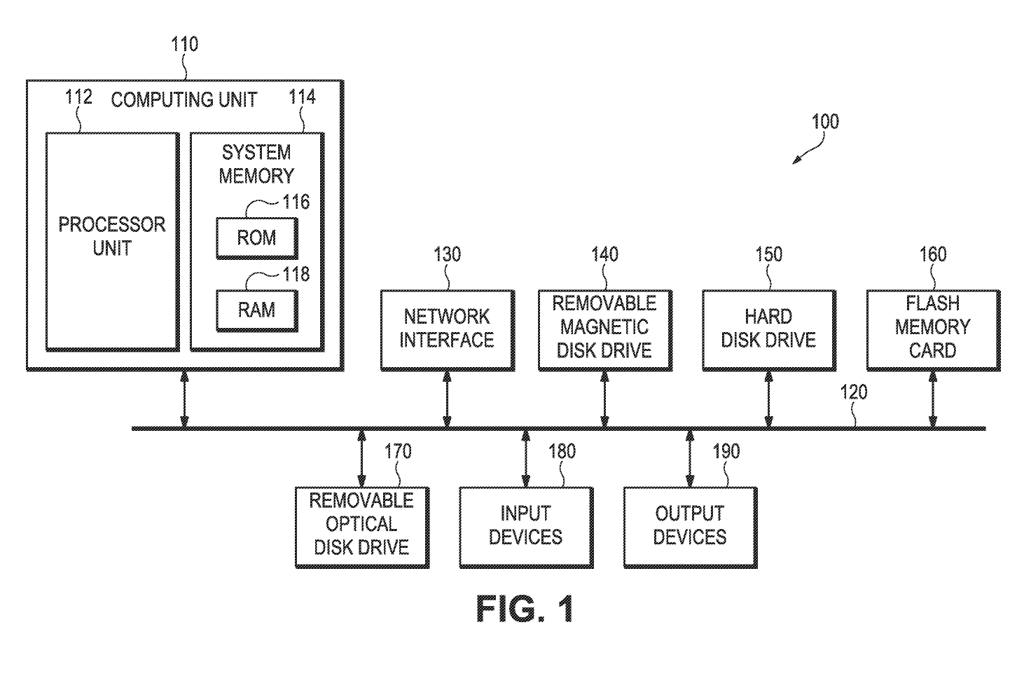

Referring to the drawings, wherein like reference numerals represent like parts throughout the various drawing figures, FIG. 1 shows a schematic view of a programmable computing device 100.

Various examples of the present invention may be implemented using electronic circuitry (not shown) configured to perform one or more functions. For example, with some embodiments of the invention, the schedule-sensitive shopping cart system may be implemented using one or more ASICs. More typically, however, components of various examples of the invention will be implemented using a programmable computing device or computer 100 executing firmware or software instructions, or by some combination of purpose-specific electronic circuitry and firmware or software instructions executing on a programmable computing device or computer 100.

Accordingly, FIG. 1 shows one illustrative example of a computer 100 that can be used to implement various embodiments of the invention. The computer 100 may be incorporated within a variety of consumer electronic devices, such as personal media players, cellular phones, smart phones, personal data assistants, global positioning system devices, and the like.

As seen in this figure, computer 100 has a computing unit 110. Computing unit 110 typically includes a processor or processing unit 112 and a system memory 114. Processing unit 112 may be any type of processing device for executing software instructions, but will conventionally be a microprocessor device. System memory 114 may include both a read-only memory (ROM) 116 and a random access memory (RAM) 118. As will be appreciated by those of ordinary skill in the art, both read-only memory (ROM) 116 and random access memory (RAM) 118 may store software instructions to be executed by processing unit 112.

Processing unit 112 and systems memory 114 are connected, either directly or indirectly, through a bus 120 or alternate communication structure to one or more peripheral devices. For example, processing unit 112 or system memory 114 may be directly or indirectly connected to additional memory storage, such as a removable magnetic disk drive 140, a hard disk drive 150, a flash memory card 160, and a removable optical disk drive 170. Processing unit 112 and system memory 114 also may be directly or indirectly connected to one or more input devices 180 and one or more output devices 190. Input devices 180 may include, for example, a keyboard, touch screen, a remote control pad, a pointing device (such as a mouse, touchpad, stylus, trackball, or joystick), a scanner, a camera or a microphone. Output devices 190 may include, for example, a monitor display, an integrated display, television, printer, stereo, or speakers.

Still further, computing unit 110 will be directly or indirectly connected to one or more network interfaces 130 for communicating with a network. This type of network interface 130, also sometimes referred to as a network adapter or network interface card (NIC), translates data and control signals from computing unit 110 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 130 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device 100 may be connected to a variety of other peripheral devices, including some that may perform input, output and storage functions, or some combination thereof. For example, the computer 100 may be connected to a digital music player (not shown), such as an IPOD® brand digital music player. As known in the art, this type of digital music player can serve as both an output device for a computer (e.g., outputting music from a sound file or pictures from an image file) and a storage device.

In addition to a digital music player, computer 100 may be connected to or otherwise include one or more other peripheral devices, such as a telephone (not shown). The telephone may be, for example, a wireless “smart phone,” such as IPHONE® or Droid® brand smart phones. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.) recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 100 so that their data maintained may be synchronized.

Of course, still other peripheral devices may be included with or otherwise connected to a computer 100 of the type illustrated in FIG. 1, as is well known in the art. In some cases, a peripheral device may be permanently or semi-permanently connected to computing unit 110. For example, with many computers, computing unit 110, hard disk drive 150, removable optical disk drive 170, and a display (not shown) are semi-permanently encased in a single housing.

Still other peripheral devices may be removably connected to computer 100, however. Computer 100 may include, for example, one or more communication ports (not shown) through which a peripheral device can be connected to computing unit 110 (either directly or indirectly through bus 120). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 100 may include a wireless data “port,” such as a Bluetooth® interface, a Wi-Fi interface, an infrared data port, or the like.

It should be appreciated that a computing device 100 may include more components than computer 100 illustrated in FIG. 1, fewer components than computer 100, or a different combination of components than computer 100. Some implementations of the invention, for example, may employ one or more computing devices 100 that are intended to have a very specific functionality, such as a smart phone or server computer. These computing devices may thus omit unnecessary peripherals, such as the network interface 130, removable optical disk drive 140, printers, scanners, external hard drives, etc. Some implementations of the invention may alternately or additionally employ computing devices 100 that are intended to be capable of a wide variety of functions, such as a desktop or laptop personal computer. These computing devices 100 may have any combination of peripheral devices or additional components as desired.

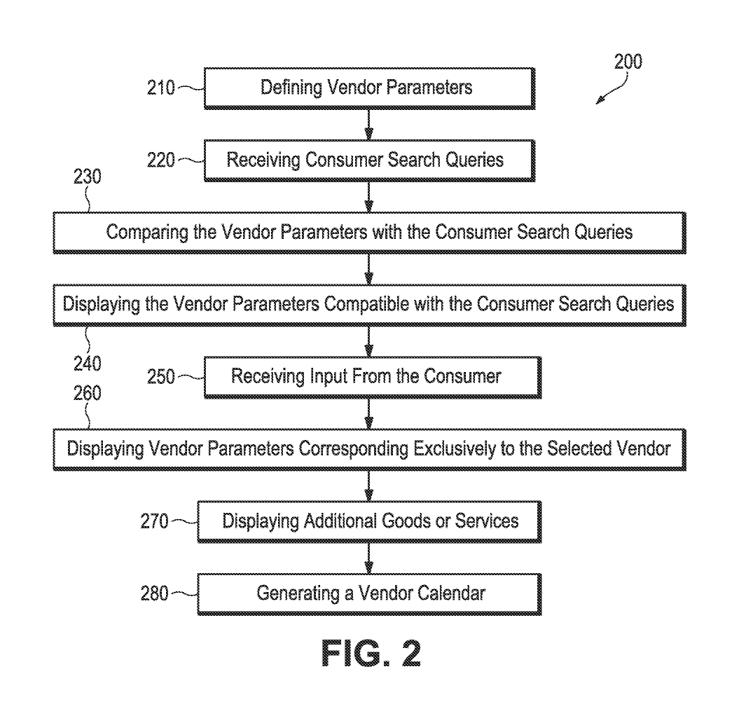

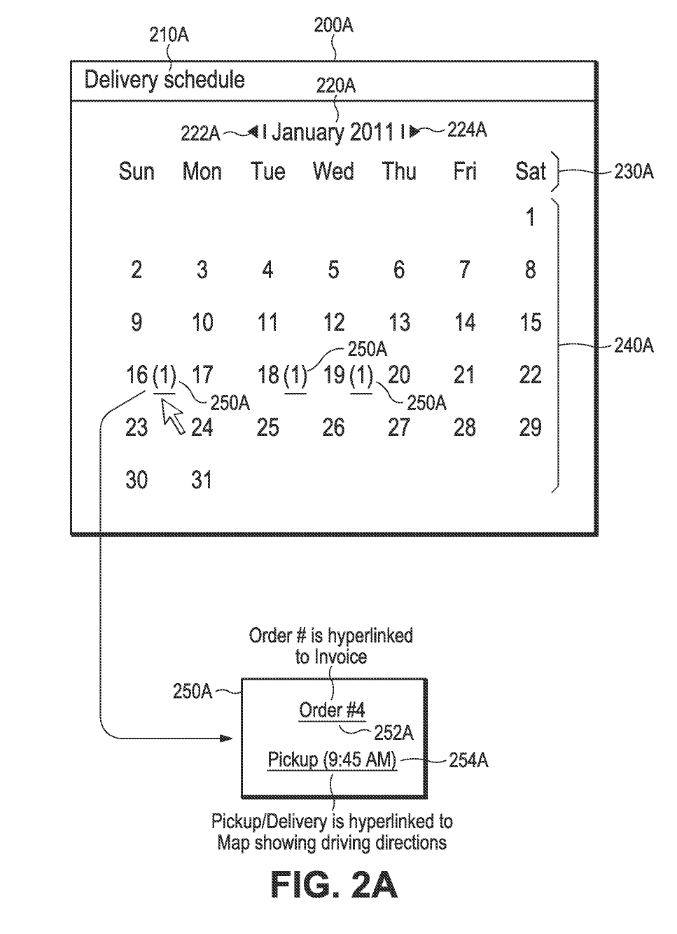

Example methods may be better appreciated with reference to the flow diagrams of FIGS. 2-4. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional steps that are not illustrated in blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software ogle may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented, and/or artificial intelligence techniques. The foregoing applies to all methodologies herein.

Referring now to FIG. 2, an example methodology 200 is illustrated that can be associated with an automated, schedule-sensitive shopping cart system. The example methodology 200 will be described with reference to an example configuration where a user configures a networked computer system 100 including a central processing unit 110 and a shared data storage 114 cooperating with the central processing unit, as shown in FIG. 1. In block 210, seller/vendors define vendor parameters for goods and services offered by each vendor. The vendor parameters include a vendor defined product category, a product description, time-sensitive quantity availability, and one or more of local pickup parameters and local delivery parameters. The local pickup parameters include a local pickup location and a local pickup timeframe, and the local delivery parameters include a. geographic delivery region, and a local delivery timeframe. The local pickup parameters and the local delivery parameters of block 210 may include an advance notification time.

Next, as shown in block 220, consumer search queries are received by the computer. The consumer search queries include a consumer desired product category, local pickup preferences, and local delivery preferences. The local pickup preferences include a geographic location of the buyer-consumer, an acceptable pickup travel distance, a pickup travel time, a desired pickup time, and a pickup date. The local delivery preferences include a desired delivery location, a desired delivery time, and a desired delivery date. The local pickup timeframe and the local delivery timeframe as well as the pickup travel time, the desired pickup time, and the desired delivery time of block 220 may be defined with a precision o the nearest minute.

With continuing reference to FIG. 2, block example methodology is illustrated for comparing the vendor parameters with the consumer search queries. In block 240, methodology is shown for displaying to the consumers for purchase consideration, the vendor parameters compatible with the consumer search queries. The display of vendor parameters at step 240 defines a first display of vendor parameters. The computer may receive input from the consumer corresponding to a selected vendor from the first display of vendor parameters, at block 250.

In some examples, receiving input from the consumer includes filtering the search results by clicking on a selected vendor. In other examples, receiving input from the consumer includes the consumer entering additional search criteria, such as vendor name or geographic region, or reentering all search criteria with the additional search criteria included. Receiving input from the consumer may additionally or alternatively include selecting a product and entering date and time criteria for comparison with product date and time availability parameters entered by the seller.

Next, block 260 illustrates the methodology for displaying vendor parameters that correspond exclusively to the selected vendor. Block 260 may be used to define a second display of vendor parameters.

In the example methodology 200, the vendor parameters of step 260 may further include a payment parameter defining that the seller/vendor will accept Cash On Delivery payment, by cash, check, credit card, or any other form of acceptable payment in person, upon delivery of the goods and services. Additionally, the vendor parameters may include a payment parameter defining that the seller/vendor will accept Cash On Delivery payment by cash, check, credit card, or any other form of acceptable payment in person, upon local pickup of the goods and services.

Payment by cash-on-delivery is a feature not present in many existing online ecommerce solutions and is a preferred payment method in various instances. For example, some consumers prefer to limit their use of credit cards online because of concerns over identity theft and/or fraudulent transactions. Further, paying offline in person may be more convenient than paying online in advance. Moreover, withholding the payment until the product is delivered or picked up or when the service is rendered enables a consumer to withhold or reduce payment if the product or service is not what the consumer ordered or the quality is not acceptable. In addition, some consumers do not possess credit cards, out of personal preference or because of low credit score rankings, and thus are not able to pay for products in advance by credit card.

FIG. 2 illustrates in block 270 the methodology for displaying to the consumer additional goods and services offered by the selected vendor for purchase consideration. There is also a processing step for generating a vendor calendar of the scheduled orders and order details, showing the date and time of the local pickup and the date and time of the local delivery, in a calendar format, as shown in block 280. The vendor calendar 200A will be further described below with reference to FIG. 2A.

Processing methodology 200 may further include a processing step (not shown) for reporting invoices via email to both vendors and consumers.

Referring now to FIG. 2A, a vendor calendar 200A is illustrated as a screen display, in a non-limiting embodiment of an automated, schedule sensitive shopping cart system. The vendor calendar 200A can be used for showing all past, present, and future orders placed for the goods and services offered by each vendor/seller. Each vendor can access a vendor calendar 200A for order processing, and every local pickup and delivery order is viewable on calendar 200A. The calendar 200A may include a label, such as Delivery Schedule 210A shown in FIG. 2A. In addition, calendar 200A may be printable and available as a hard copy.

It should be appreciated that calendar 200A may include a monthly view or other viewing formats, such as a weekly view or a daily view. By way of non-limiting examples, the monthly view may include each day of the month, the weekly view may include each day of the week and each hour of each day of the week, and the daily view may include 30 minute intervals for the entire 24 hour period.

In a non-limiting embodiment, vendor calendar 200A may be viewable in a monthly format which may include the month and year 220A, such as “January 2011”, and previous 222A and next 224A selectors for selecting and viewing either the previous month or next month in sequence. The days of the week 230A and each day 240A of the month is illustrated. It will be appreciated by one of ordinary skill in the art, in the monthly view as seen in FIG. 2A, as well as a weekly view or daily view or the like, that various selectors, buttons, radio buttons and hyperlinks may used to access and process the components and features of the vendor calendar 200A.

With continuing reference to FIG. 2A, a hyperlink 250A may be included for showing a hyperlink list of orders placed. When the hyperlinked 250A is opened and accessed, it may further provide an order number 252A and a pickup/delivery time 254A. The order number 252A can be hyperlinked to an invoice (not shown), and the pickup/delivery time 254A may be hyperlinked to a map (not shown) for showing driving directions. It should be appreciated that buyers would also be afforded the use of a calendar with more or less components and features of the vendor calendar 200A.

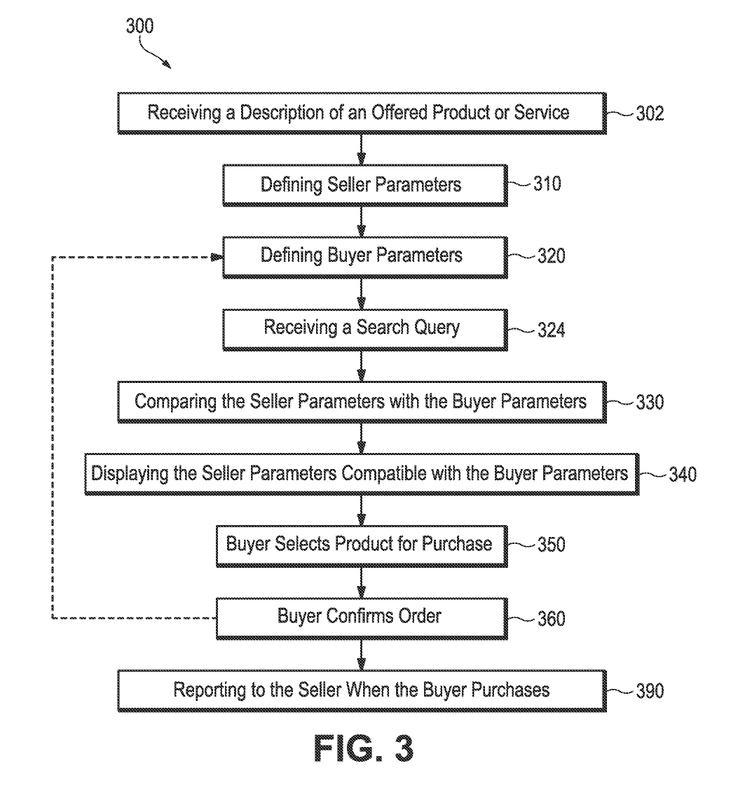

Referring now to FIG. 3, an example methodology 300 is illustrated that can be associated with a non-limiting embodiment of an automated, schedule-sensitive shopping cart system. The example methodology 300 will be described with reference to an example configuration where a user configures a networked computer system 100 including a central processing unit 110 and a shared data storage 114 cooperating with the central processing unit, as shown in FIG. 1.

In block 302 of FIG. 3, the process step for receiving a description of an offered product or service from a seller is shown. Block 310 shows defining seller parameters corresponding to the offered product or service, via data input from the sellers. The seller parameters may include an availability setting defined with a precision to the nearest minute, and the availability setting specifies calendar scheduling time periods controlled by the seller. The calendar scheduling time periods may include automatically recurring time periods.

With continuing reference to FIG. 3, block 320 defines buyer parameters corresponding to the desired product or service, via data input from the buyer. The buyer parameters may include an acceptance setting defined with a precision to the nearest minute. Block 324 illustrates receiving a search query from a buyer for a desired product or service.

In FIG. 3, the processing methodology of block 330 shows comparing the seller parameters with the buyer parameters when the offered product or service matches the desired product or service. Also, in block 340, the seller parameters compatible with the buyer parameters are displayed to the buyer for purchase consideration. Block 350 shows the buyer selects product for purchase by selecting either the offline Cash On Delivery payment method, or by paying in advance via an online payment method, and in block 360, the buyer confirms the order, which then schedules an appointment for the buyer and seller to meet for the pickup or delivery of the ordered goods or services.

An arrow is shown, looping block 360 back to block 320 to demonstrate that these processing steps 320-360 may be repeated.

In addition, block 390 shows reporting to the seller when the buyer purchases the offered product or service. In some examples, reporting to the seller at step 390 includes automatically preparing an invoice for the purchased products.

Processing methodology 300 may further include a processing step (not shown) for reporting invoices via email to both buyers and sellers.

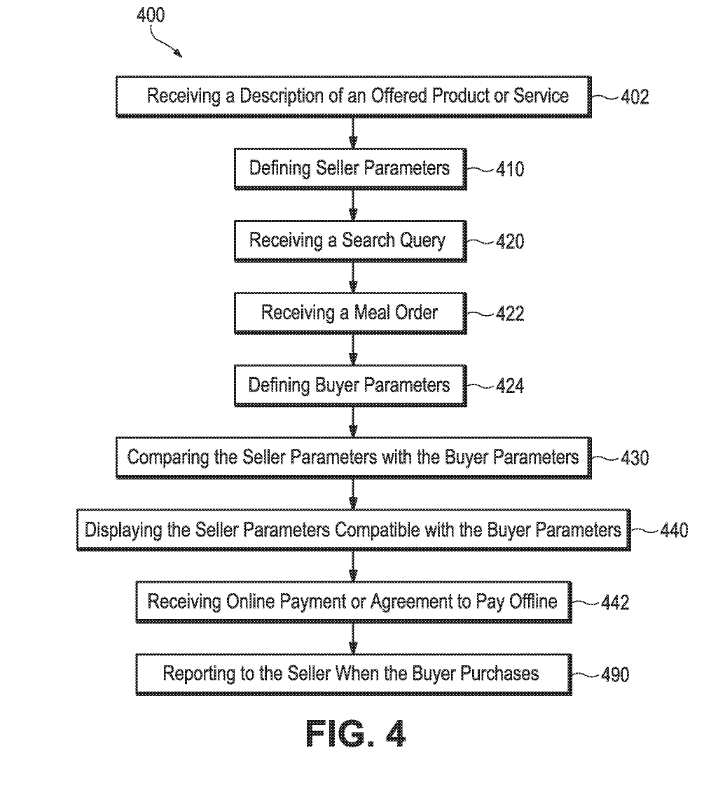

Referring now to FIG. 4, an example methodology 400 is illustrated that can be associated with a non-limiting embodiment of an automated, schedule-sensitive shopping cart system where the offered product or service may include a meal at a restaurant. The example methodology 400 will be described with reference to an example configuration where a user configures a networked computer system 100 including a central processing unit 110 and a shared data storage 114 cooperating with the central processing unit, as shown in FIG. 1.

In block 402, the process step for receiving a description of an offered product or service from a seller is shown. Block 410 shows defining seller parameters corresponding to the offered product or service, via data input from the sellers. The seller parameters may include an availability setting defined with a precision to the nearest minute, and the availability setting may include a table reservation date and time at a desired restaurant.

With continuing reference to FIG. 4, block 420 illustrates receiving a search query from a buyer for a desired product or service. Block 422 is for receiving a meal order at the desired restaurant. Block 424 defines buyer parameters corresponding to the desired product or service, via data input from the buyer. The buyer parameters may include an acceptance setting defined with a precision to the nearest minute.

In FIG. 4, the processing methodology of block 430 shows comparing the seller parameters with the buyer parameters when the offered product or service matches the desired product or service. Also, in block 440, the seller parameters compatible with the buyer parameters are displayed to the buyer for purchase consideration. When the product or service is a meal in a restaurant, block 442 provides for receiving online payment or agreement to pay offline. In addition, block 490 shows reporting to the seller when the buyer purchases the offered product or service.

Processing methodology 400 may further include a processing step (not shown) for reporting invoices via email h buyers and sellers.

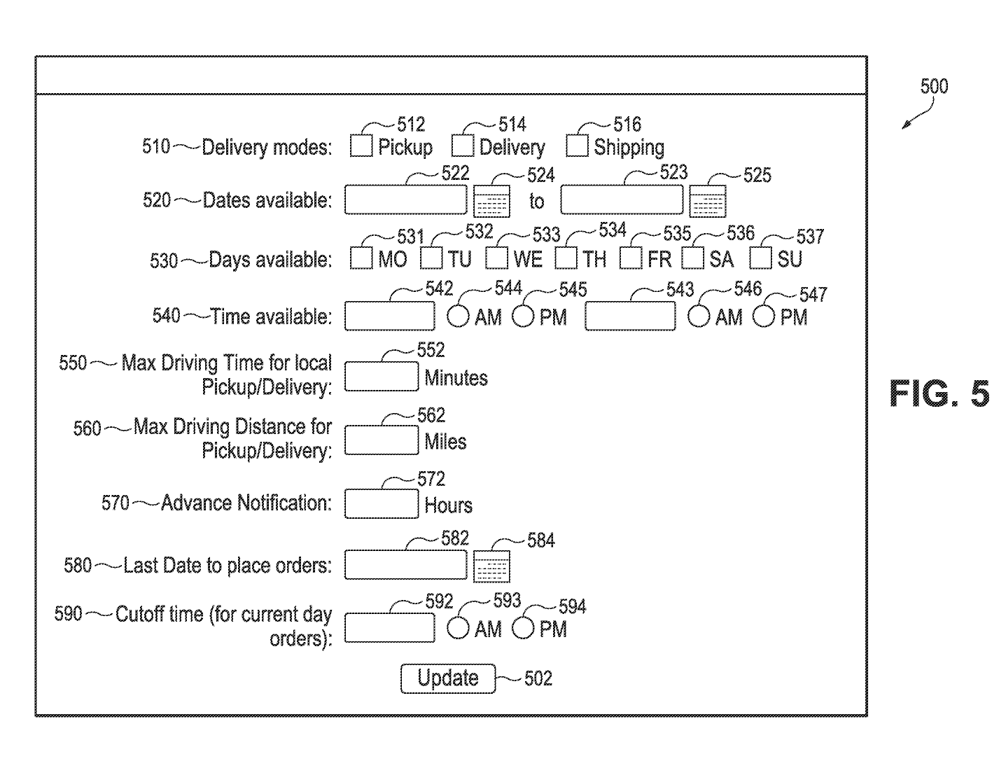

Referring now to FIG. 5, a non-limiting screenshot 500 for seller input that enables a seller to manage product availability for pickup and delivery by location, date, time, and so on is illustrated. In a non-limiting embodiment of the automated, schedule-sensitive shopping cart system, a seller may define the availability of each of his or her products to match his or her own schedule. As shown in screenshot 500, a parameter for Delivery modes 510 may be displayed to include open field boxes 512, 514, 516 for selecting any combination of Pickup 512. Delivery 514, or Shipping 516. Next, Dates available 520 may be scheduled, ranging from a beginning date to an end date, by using calendars 524 and 525 to designate open fields 522 and 523, respectively. The Dates available 520 parameter may be further defined by using Days available 530 and open fields 531-537 for selecting specific day(s) of the week. Furthermore, a Time available setting enables the seller to select time defined to nearest minute, using open field 542 and 543 with ante-meridiem, “am” 544, 546 and post-meridiem, “pm” 545, 547 designators.

With continuing reference to screenshot 500, local pickup and delivery settings may be inputted using Max Driving Time for local Pickup/Delivery 550 in Minutes 552 and Max Driving Distance for Pickup/Delivery 560 in Miles 562.

The local pickup parameters and the local delivery parameters as shown in screenshot 500 may be further defined by using the input designation for Advance Notification 570 time in Hours 572.

As illustrated in FIG. 5, a parameter for the finality of availability, having a Last Date to place orders 580 category with calendar selection 584 for input in open field 582 is shown. Also, a Cutoff time (for current day orders) 590 can be included with “am” 593 and “pm” 594 designators to input a time in open field 592.

In addition, seller input includes managing inventory availability by date and time interval. In a non-limiting example, the quantity of product and its availability can be defined by the day, and defined by time interval with a precision to the nearest minute within the day. Similarly, a meal provider can manage table availability by date and time interval, in order to prevent double-booking. In a non-limiting example, table reservations can be defined by the day, and defined by time interval with a precision to the nearest minute within the day. Thus, the seller of the meal can limit the number of reservations available based on a time interval within a day at each its designated tables.

For example, the seller may limit the frequency at which table reservations may be made for a given table by a 7 minute time interval. In this example, once a first consumer reserves a table, the option to reserve that table for another time slot will not made available be available online to a second consumer until 7 minutes after the first consumer reserved the table.

Additionally or alternatively, the seller may specify availability schedule for a product, such as a table at a restaurant, based on time intervals to a precision of the nearest minute. For example, the seller may set a schedule where table reservations may be made for 55 minute periods. Further, the seller may specify a schedule where new table reservations are available in 60 minute time intervals, such as on the hour. In this example, a first consumer may reserve a table for 55 minutes at a noon time slot, and the schedule allows a second consumer to reserve the table for a second 55 minute period at 1:00 P.M time slot.

The seller can use the Update 502 button to accept the seller controlled parameters inputted in screenshot 500.

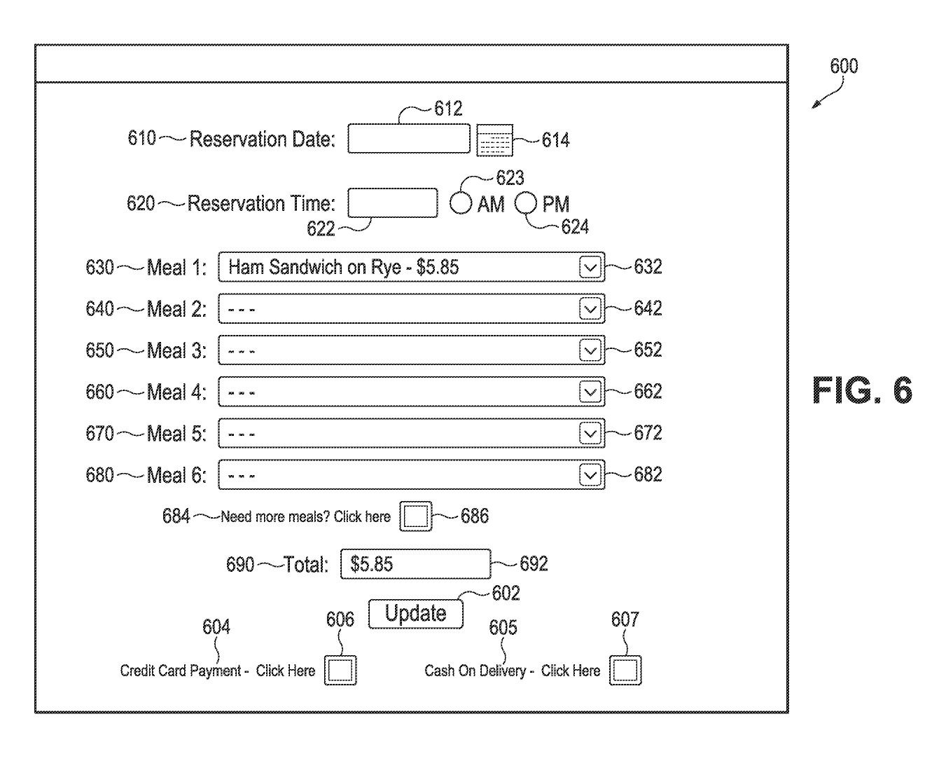

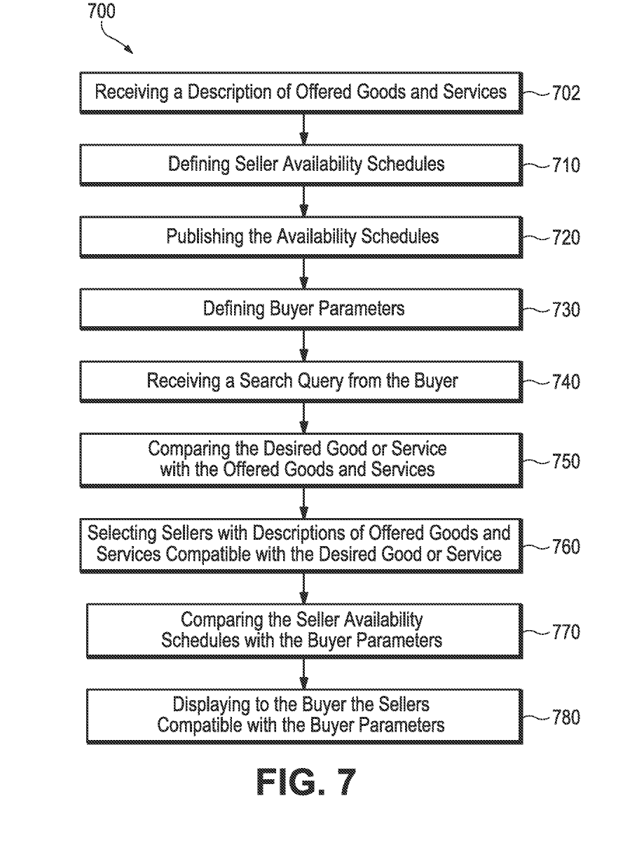

Referring now to FIG. 6, a non-limiting screenshot 600 is illustrated for buyer input that enables a buyer consumer to manage the date and time of a reservation at a restaurant, as well as order a meal. As shown in screenshot 600, the buyer may select a Reservation Date 610 using the calendar 614 and input the selected date into open field 612. Also, a Reservation Time 620 may be designated with “am” 623 and “pm” 624 buttons and open field 622 for entering a time.

With continuing reference to FIG. 6, a non-limiting number of Meal selection fields 630, 640, 650, 660, 670, 680 are shown, in which a buyer can select items from a menu of a local restaurant. Each Meal selection field 630, 640, 650, 660, 670, 680 may be accompanied with a drop down menu button 632, 642, 652, 662, 672, 682 for choosing the menu items, as entered by the seller vendor. Additional meals may be requested using the label Need more meals? Click here, shown at 684, and corresponding button 686. In some examples, a hyperlink or radio button is used instead of button 686.

Pricing for the menu items selected in the Meal fields 630, 640, 650, 660, 670, 680 can be totaled in dollars and cents as shown in FIG. 6 at the Total label 690 and value field 692,

As shown in FIG. 6, if payment by credit card is desired, the Credit Card Payment—Click Here label 604 and corresponding button 606 can be utilized. If payment by cash on delivery (or at the completion of the service of the meal) is desired, the Cash on Delivery—Click here label 605 and corresponding button 606 can be selected.

The buyer/consumer can use the Update 602 button to accept the buyer controlled parameters inputted in screenshot 600.

Referring now to FIG. 7, an example methodology 700 is illustrated that can be associated with a non-limiting embodiment of an automated, schedule-sensitive shopping cart system with a seller availability schedule. The example methodology 700 will be described with reference to an example configuration where a user configures a networked computer system 100 including a central processing unit 110 and a shared data storage 114 cooperating with the central processing unit, as shown in FIG. 1.

In block 702, the process step for receiving a description of offered goods and services from the sellers is shown. Block 710 shows defining seller availability schedules corresponding to the offered goods and services. The seller availability schedules may include a geographical region availability parameter, a date range availability parameter, and a time range availability parameter.

With continuing reference to FIG. 7, block 720 illustrates publishing the availability schedules into a searchable database. Block 730 is for defining buyer parameters via data input from the buyer. The buyer parameters may include a preferred geographical region, a preferred date range, and a preferred time range. Block 740 shows receiving a search query from the buyer for a desired good or service. Block 750 shows comparing the desired good or service from the search query with the offered goods and services.

In block 760 selecting sellers with descriptions of offered goods and services compatible with the desired good or service, where the selected sellers define a first set of sellers is next shown. Block 770 shows comparing the seller availability schedules of the first set of sellers with the buyer parameters. Block 780 shows displaying to the buyer, the sellers from the first set of sellers with seller availability schedules compatible with the buyer parameters.

Processing methodology 700 may further include a processing step (not shown) for reporting invoices via email to both buyers and sellers.

The following examples are offered to illustrate, but not to limit the claimed invention.

### EXAMPLES

### Example 1

In its industrial applicability the present invention enables sellers to list goods and services, and manage product availability for pickup and delivery by location, date, time, and so on. Buyers are free to search for sellers and their products by zip code, city, state, and date, for example, and then select a pickup or delivery date and time, add to the online shopping cart, choose to pay online or in person, and submit order. The schedule-sensitive shopping cart system can update inventory for seller/vendors, report invoices via email to both buyers and sellers, and schedule pickup and delivery appointment on the seller's calendar.

### Example 2

In its industrial applicability, the present invention enables sellers and service providers to publish their local availability parameters online into a searchable database. Buyers can then search and locate sellers by a combination of the seller's geographical region preferences and availability schedule, and match it to their own geographic region preferences and availability schedule, to locate locally available sellers and locally available gods or services from that seller.

### Example 3

In its industrial applicability, the online seller storefront made possible by the present invention may be used for prepared food, table reservations, catering, and packaged foods. For prepared food made by caterers, restaurants, and home-based kitchens, buyers can order and schedule pickup/delivery for the menu items listed. For table reservations at restaurants or catered events, Guests can reserve tables for a desired date and time and can also order from the menu prior to the scheduled arrival time. For catering, the catering event, including the menu orders can be automated and scheduled online. Packaged foods, such as from wineries, meat shops, local markets, home-based kitchens, bakeries and pastry shops, specialty items and fragile, decorated items can be ordered for local pickup and delivery.

### Example 4

In its industrial applicability, the online seller storefront enabled by the present invention may be used for automating schedule-sensitive seasonal farm and ranch-direct orders, local market sales, consumer supported agriculture subscriptions, and wholesale discounts. The present invention may include a searchable category and map-based farm and ranch locator; local product availability schedule, search, and ordering by date, time, and location; advance pickup orders for farmers markets; cash on delivery (COD) payment options; calendar view of scheduled pickup and delivery orders; seller managed coupons and discounts; and easy store integration into existing websites.

From the foregoing description it will be apparent that modifications can be made to the schedule-sensitive shopping cart system without departing from the teachings of the invention.

The instant invention may be embodied in other forms or carried out in other ways without departing from the spirit or essential characteristics thereof. The present disclosure is therefore to be considered as in all respects illustrative and not restrictive, the scope of the invention being indicated by the appended claims, and all equivalency are intended to be embraced therein. One of ordinary skill in the art would be able to recognize equivalent embodiments of the instant invention and be able to practice such embodiments using the teaching of the instant disclosure and only routine experimentation.

What is claimed is:

1. A method of online electronic commerce for vendors and consumers selling and purchasing, respectively, at least one of goods and services via a networked computer system including a central processing unit and a shared data storage cooperating with the central processing unit, the method comprising the steps of:
defining, by the processing unit executing logic, vendor parameters for each at least one of goods and services offered by each vendor, the vendor parameters including a vendor defined product category, a product description, and one or more of local pickup parameters and local delivery parameters, where the local pickup parameters include a local pickup location and a local pickup timeframe, and where the local delivery parameters include a geographic delivery region, and a local delivery timeframe;
receiving consumer search queries, the consumer search queries including a consumer desired product category and one or more of local pickup preferences and local delivery preferences, where the local pickup preferences include a geographic location of the consumer, an acceptable pickup travel distance, a pickup travel time, a desired pickup time and a pickup date, and the local delivery preferences include a desired delivery location, a desired delivery time and a desired delivery date;
comparing, with the processing unit executing logic, the vendor parameters with the consumer search queries, and
displaying to the consumers for purchase consideration the vendor parameters compatible with the consumer search queries.

2. The method of claim 1, wherein one or more of the local pickup parameters and the local delivery parameters include an advance notification time.

3. The method of claim 1, wherein one or more of the local pickup timeframe, the local delivery timeframe, the pickup travel time, he desired pickup time, and the desired delivery time are defined with a precision to the nearest minute.

4. The method of claim 1, wherein the vendor parameter includes an availability time interval specifying how much time must span after a consumer purchases a given type of the at least one of goods and services before the given type of the at least one of goods and services is available again for purchase.

5. The method of claim 1, wherein the vendor parameters further include a payment parameter defining that the vendor will accept offline payment by cash, check, credit card, or other form of in-person payment upon delivery of the at least one of goods and services.

6. The method of claim 1, wherein the vendor parameters further include a payment parameter defining that the vendor accept Cash On Delivery payment by cash, check, credit card, or other form of in-person pay me upon local pickup of the at least one of goods and services.

7. The method of claim 1, further comprising generating a vendor calendar that displays a scheduled appointment that includes a date and a time of the local pickup timeframe and the local delivery time-frame in a calendar format.

8. The method of claim 1, wherein the step of displaying to the consumers for purchase consideration the vendor parameters compatible with the consumer search queries defines a first display of vendor parameters and further comprising:
receiving input the consumer corresponding to a selected vendor from the first display of vendor parameters; and
displaying vendor parameters corresponding exclusively to the selected vendor to define a second display of vendor parameters.

9. The method of claim 8, further comprising displaying to the consumer additional goods and services offered by the selected vendor for purchase consideration.

10. A method of electronic commerce over an online network implemented by a central processing unit executing logic, comprising:
receiving a description of an offered product or service from a seller;
defining, with the central processing unit from data input from the seller, seller parameters corresponding to the offered product or service, the seller parameters including an availability setting defined with a precision to the nearest minute;
receiving a search query from a buyer for a desired product or service;
defining, with the central processing unit from data input from the buyer, buyer parameters corresponding the desired product or service, the buyer parameters including at least one acceptance setting defined with a precision to the nearest minute;
comparing, with the central processing unit executing logic when the offered product or service matches the desired product or service, the seller parameters with the buyer parameters; and
displaying to the buyer the seller parameters compatible with the buyer parameters for purchase consideration.

11. The method of claim 10, further comprising reporting to the seller when the buyer purchases the offered product or service.

12. The method of claim 10, wherein the availability setting specifies calendar scheduling time periods controlled by the at least one seller.

13. The method of claim 12, wherein the calendar scheduling time periods include automatically recurring time periods.

14. The method of claim 10, wherein the offered product or service is a meal at a restaurant and the availability setting includes a table reservation date and time.

15. The method of claim 14, further comprising:
receiving a meal order in advance from the buyer; and
receiving payment for the meal prior to the table reservation date and time.

16. A method of online electronic commerce for advertising, scheduling, selling and purchasing at least one of goods and services in a networked computer system including a central processing unit that acts as a shared processing location for a plurality of local vendors and a plurality of local consumers, and a shared data storage that acts cooperatively the central processing unit and serves as a shared data storage for the plurality of vendors and the plurality of consumers, the method comprising the steps of:
defining, by the central processing unit executing logic, vendor parameters for each at least one of goods and services offered by each vendor, the vendor parameters including a vendor defined product category, a product description, and an availability schedule specifying time periods when each good is available for pickup or delivery and when each service is available to be rendered,
receiving consumer search queries, the consumer search queries including a consumer desired product category and one or more of local pickup preferences and local delivery preferences, where the local pickup preferences include desired time to pickup each good and to receive each service from a vendor premises, and the local delivery preferences include a desired time to have each good delivered and to have each service rendered outside of the vendor premises,
comparing, with the processing unit executing logic, the vendor parameters with the consumer search queries, and
displaying to the consumers for purchase consideration the vendor parameters compatible with the consumer search queries.

17. The method of claim 16, wherein:
the vendor parameters further comprise local pickup parameters including a local pickup location and pickup schedule; and
the local pickup preferences include a geographic location of the consumers and an acceptable pickup travel distance and pickup travel time.

18. The method of claim 16, wherein:
the vendor parameters further comprise local delivery parameters including a geographic delivery region; and
the local delivery preferences include a desired delivery location and a delivery time.

19. The method of claim 16, wherein the availability schedule is defined with a precision to the nearest minute.

20. The method of claim 16, wherein the vendor parameters further include a payment parameter defining that the vendor will accept offline payment by cash, check, credit card, or other form of in-person payment upon local pickup or local delivery of a product or service.

21. A method of online electronic commerce for sellers and buyers selling arid purchasing, respectively, goods and services via a networked computer system including a central processing unit and a shared data storage cooperating with the central processing unit, the method comprising the steps of:
receiving a description of offered goods and services from the sellers;
defining, with the central processing unit from data input from the sellers, seller availability schedules corresponding to the offered goods and services, the seller availability schedules including a geographical region availability parameter, a date range availability parameter, and a time range availability parameter;
publishing, with the central processing unit, the availability schedules into a searchable database;
defining, with the central processing unit from data input from a buyer, buyer parameters including a preferred geographical region, a preferred date range, and a preferred time range;
receiving a search query from the buyer for a desired good or service;
comparing the desired good or service from the search query with the offered goods and services,
selecting, with a central processing unit, sellers with descriptions of offered goods and services compatible with the desired good or service, where the selected sellers define a set of sellers;
comparing, with the central processing unit executing logic, the seller availability schedules of the first set of sellers with the buyer parameters; and
displaying to the buyer the sellers from the first set of sellers with seller availability schedules compatible with the buyer parameters.
